(19) United States
(12) Patent Application Publication
(10) Pub. No.: US 2020/0102785 A1
(43) Pub. Date: Apr. 2, 2020

(54) BLIND WITHOUT PULL CORD AND ANGLE ADJUSTMENT DEVICE THEREOF

(71) Applicant: FRESH SPRING INTERNATIONAL,INC., New Taipei (TW)

(72) Inventor: Chih-Ming Hsieh, New Taipei (TW)

(21) Appl. No.: 16/273,277

(22) Filed: Feb. 12, 2019

(30) Foreign Application Priority Data
Sep. 28, 2018 (TW) 107134306

(51) Int. Cl. E06B 9/307; E06B 9/304; E06B 9/308; E06B 9/326

(52) U.S. Cl. CPC E06B 9/307; E06B 9/304; E06B 2009/285; E06B 9/326; E06B 9/308

(57) ABSTRACT

The disclosure is related to a blind without pull cord and an angle adjustment device thereof, wherein the angle adjustment device is configured to adjust angles of slats of a blind and includes at least one adjustment assembly and a shaft. The at least one adjustment assembly includes a mount base, a string pulley, a first gear and a first string. The string pulley is pivotably disposed on the mount base. The first gear is fixed on the string pulley. The first string is installed on the string pulley and is configured to connect the slats. The shaft includes a lengthy part and at least one outer tooth fixed on the lengthy part, wherein the at least one outer tooth is engaged with the first gear. An axis of the first gear is perpendicular to an axis of the shaft.

### CROSS-REFERENCE TO RELATED APPLICATIONS

This non-provisional application claims priority under 35 U.S.C. § 119(a) on Patent Application No(s). 107134306 filed in Taiwan, R.O.C. on Sep. 28, 2018, the entire contents of which are hereby incorporated by reference.

### TECHNICAL FIELD

The disclosure relates to a blind and an angle adjustment device thereof.

### BACKGROUND

Blinds are used to control the intensity of the light penetrating through the window by lowering/raising the slats and by adjusting the angles of the slats. Therefore, blinds usually include a lowering/raising mechanism and an angle adjustment mechanism. Additionally, the lowering/raising mechanism and the angle adjustment mechanism are disposed in the headrail of the blinds. The angle adjustment mechanism includes a string that serially connects the slats, a gear that changes the angles of the slats by moving the string, and a shaft that makes the operation convenient. In general, the gear stands on the headrail and an axis of the gear is parallel to that of the shaft.

### SUMMARY

An embodiment of the disclosure provides an angle adjustment device configured to adjust angles of slats of a blind. The angle adjustment device includes at least one adjustment assembly and a shaft. The at least one adjustment assembly includes a mount base, a string pulley, a first gear and a first string. The string pulley is pivotably disposed on the mount base. The first gear is fixed on the string pulley. The first string is installed on the string pulley and is configured to connect the slats. The shaft includes a lengthy part and at least one outer tooth fixed on the lengthy part, wherein the at least one outer tooth is engaged with the first gear. An axis of the first gear is perpendicular to an axis of the shaft.

Another embodiment of the disclosure provides a blind including a headrail, an angle adjustment device, a raising mechanism and a plurality of slats. The headrail includes a bottom plate and two side plates. The two side plates are respectively disposed at two opposite sides of the bottom plate. The two side plates and the bottom plate together form an accommodating space. The angle adjustment device is disposed in the accommodating space. The raising mechanism includes a roller and at least one second string. The roller is disposed in the accommodating space and is rotatably disposed on the mount base of the at least one adjustment assembly. The at least one second string is installed on the roller. The plurality of slats, the first string and the least one second string connect the plurality of slats so that the plurality of slats are hung on a side of the headrail. The first gear is located between the roller and the bottom plate.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a prospective view of a blind according to a first embodiment of the disclosure;

FIG. 2 is a partially enlarged exploded view of the blind in FIG. 1;

FIG. 3 is a perspective view of an adjustment assembly and a second string of the blind in FIG. 1;

FIG. 4 is a partially enlarged exploded view of a raising mechanism of the blind in FIG. 1; and

FIG. 5 is a partially enlarged cross-sectional view of the raising mechanism of the blind in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

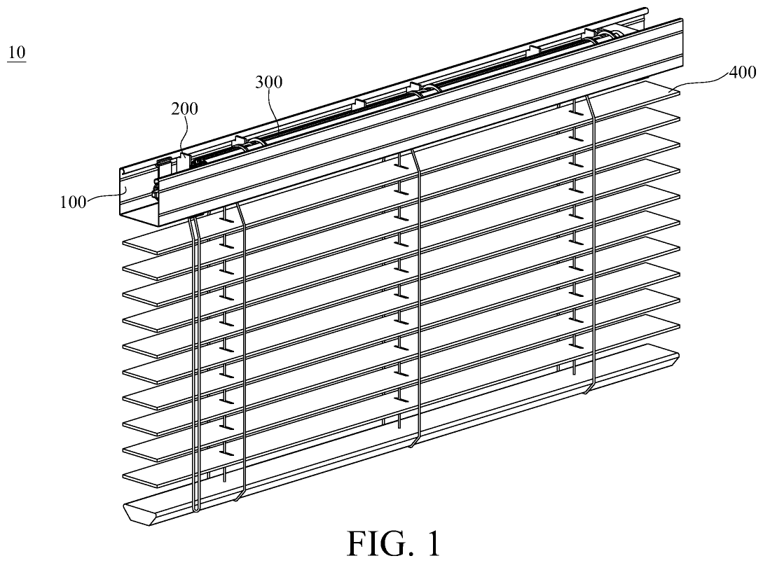

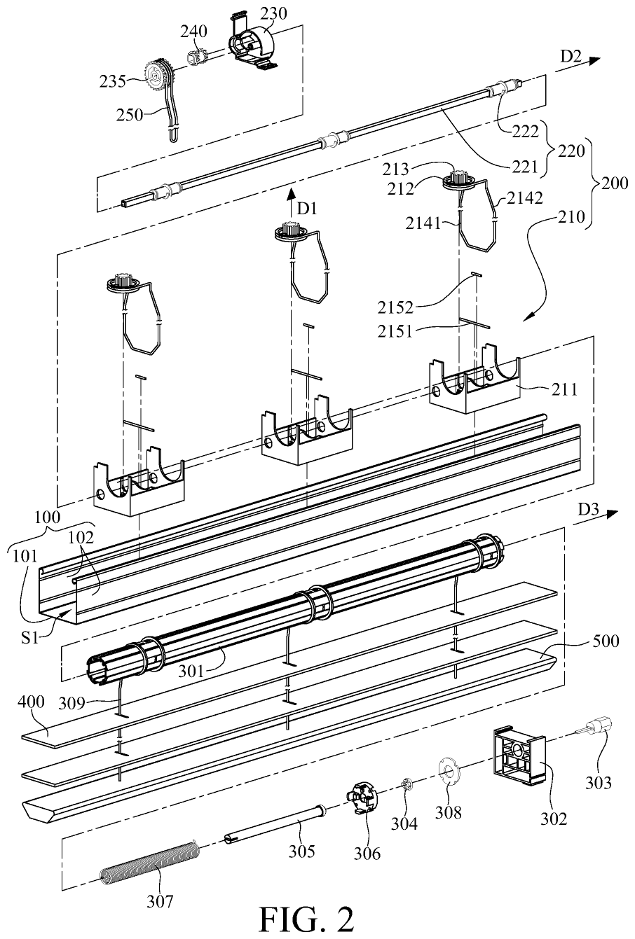

Please refer to FIG. 1 and FIG. 2, FIG. 1 is a prospective view of a blind according to a first embodiment of the disclosure, and FIG. 2 is a partially enlarged exploded view of the blind in FIG. 1.

This embodiment provides a blind 10. The blind 10 includes a headrail 100, an angle adjustment device 200, a raising mechanism 300 and a plurality of slats 400.

The headrail 100 includes a bottom plate 101 and two side plates 102. The two side plates 102 are respectively located at two opposite sides of the bottom plate 101. The two side plates 102 and the bottom plate 101 together form an accommodating space S1.

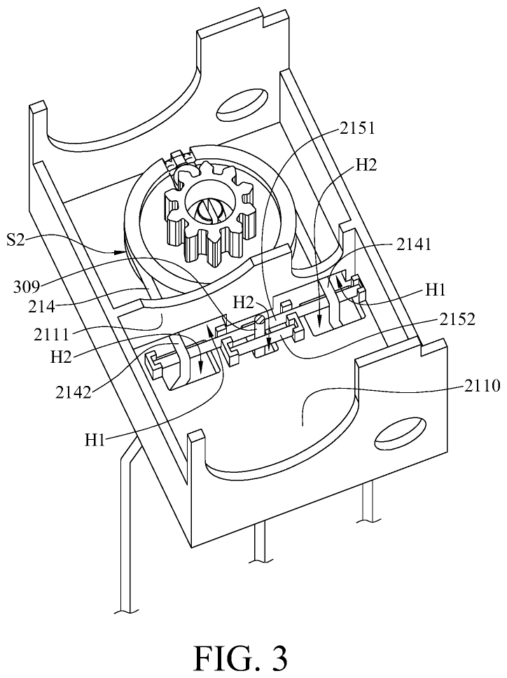

Please refer to FIG. 2 and FIG. 3. FIG. 3 is a perspective view of an adjustment assembly and a second string of the blind in FIG. 1. The angle adjustment device 200 is disposed in the accommodating space S1 and includes at least one adjustment assembly 210 and a shaft 220.

The amount of the at least one adjustment assembly 210 is, for example, three, and each adjustment assembly 210 includes a mount base 211, a string pulley 212, a first gear 213, and a first string 214.

In each adjustment assembly 210, the mount base 211 includes a main body 2110 and an assemble board 2111. The main body 2110 is disposed on the bottom plate 101. The assemble board 2111 stands on the main body 2110. The assemble board 2111 has, for example, two first through holes H1 separated from each other, and the main body 2110 has, for example, three second through holes H2 that are arranged along in a direction. but the disclosure is not limited thereto. In other embodiments, the assemble board may have two first through holes connected to each other so as to form a larger through hole, and the main body may have three second through holes connected to one another so as to form a larger through hole as well. Furthermore, in another embodiment, the assemble board may have no first through hole, and the main body may have no second through hole.

In each adjustment assembly 210, the string pulley 212 is pivotably disposed on the main body 2110 and has a groove S2. In addition, the first gear 213 is immovably fixed on the string pulley 212. That is, the first gear 213 is pivotably disposed on the main body 2110 of the mount base 211 via the string pulley 212.

Also, in each adjustment assembly 210, the first string 214 is a single piece and is installed in the groove S2 of the string pulley 212. In this embodiment, the first string 214 is defined to have a first adjustment portion 2141 and a second adjustment portion 2142 by the string pulley 212. As shown in FIG. 2 and FIG. 3, the first adjustment portion 2141 and the second adjustment portion 2142 are respectively located at two opposite sides of the groove S2, are respectively disposed through the two first through holes H1, and are respectively disposed through the two outermost second through holes H2.

Moreover, each adjustment assembly 210 further includes a smooth rod 2151 and a smooth rod 2152 that are disposed on the main body 2110. The smooth rod 2151 is longer than the smooth rod 2152. The smooth rod 2151 is located above all of the second through holes H2, and the smooth rod 2152 is located above the middle second through hole H2. In more detail, the smooth rod 2151 and 2152 are made of, for example, metal, and have smooth surfaces, and the first adjustment portion 2141 and the second adjustment portion 2142 respectively cross over and are in contact with the smooth rod 2151 and the smooth rod 2152. Since the surfaces of the smooth rod 2151 and 2152 are smooth, the smooth rod 2151 and 2152 allow the first string 214 to move smoothly and would not wear the first string 214. However, the smooth rod 2151 and 2152 are optional; in other embodiments, the adjustment assembly may have no any smooth rod.

The shaft 220 includes a lengthy part 221 and at least one outer tooth 222. The amount of the at least one outer tooth 222 is, for example, three. In detail, the three outer teeth 222 are fixed on the lengthy part 221 and separated from one another. The three outer teeth 222 are able to be respectively engaged with and to rotate the first gears 213 of the adjustment assemblies 210. In more detail, each first gear 213 has an axis D1 perpendicular to an axis D2 of the shaft 220. Further, the outer tooth 222 and the first gear 213 have a gear ratio of, for example, 1:10.

The angle adjustment device 200 further includes a gear mount base 230, a second gear 235, a third gear 240 and a cord 250. The gear mount base 230 is fixed on the bottom plate 101. The second gear 235 is pivotably disposed on the gear mount base 230. The second gear 235 is engaged with the third gear 240. The shaft 220 is fixed to the third gear 240, such that the third gear 240 is able to rotate the first gear 213 by rotating the shaft 220. The second gear 235 and the third gear 240 have a gear ratio of, for example, 2:1.

The cord 250 is installed on the second gear 235 and is able to rotate the second gear 235, but the disclosure is not limited thereto. In other embodiments, the cord may be implemented as an operating assembly that includes a worm shaft, a worm wheel and an operating shaft, wherein the worm is fixed to the second gear, the worm wheel is engaged with the worm shaft and the operating shaft is fixed to the worm wheel so that the operating rob is able to rotate the second gear via the worm shaft and the worm wheel.

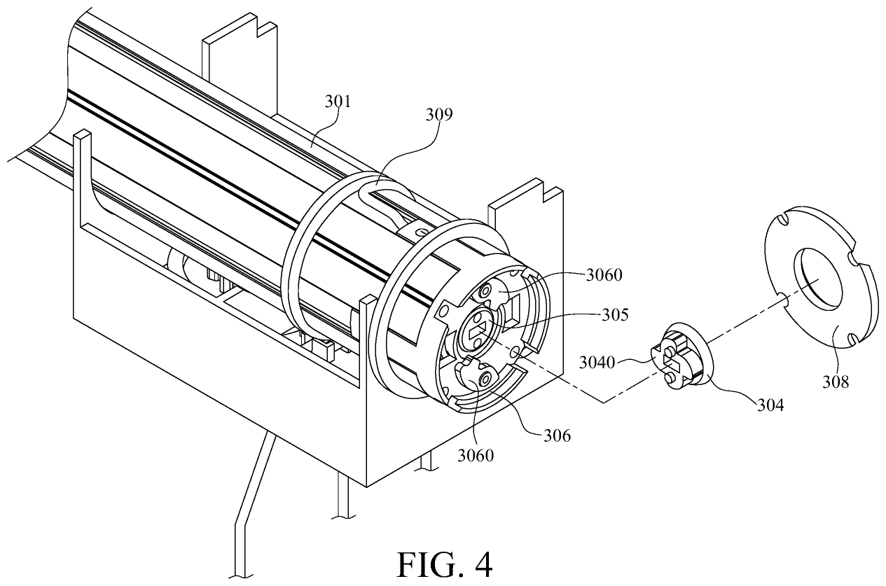

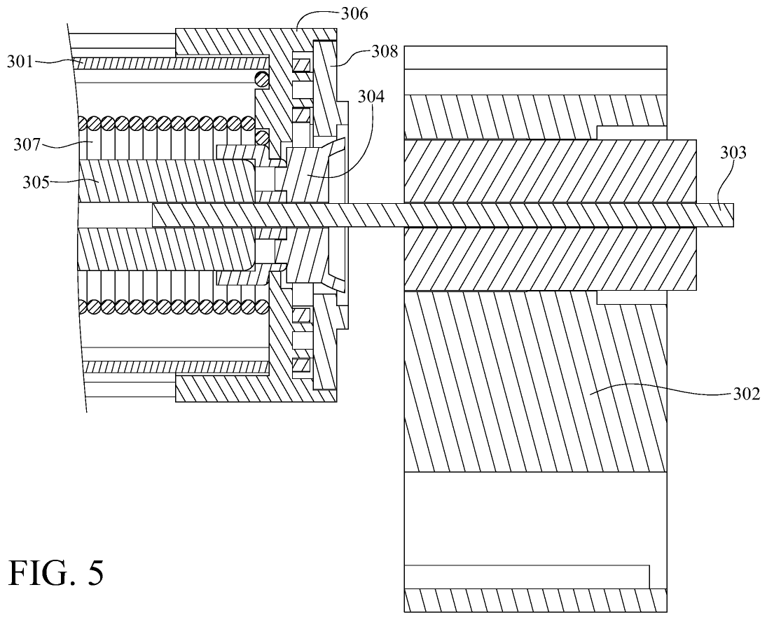

Then, please refer to FIG. 2 to FIG. 5. FIG. 4 is a partially enlarged exploded view of a raising mechanism of the blind in FIG. 1. FIG. 5 is a partially enlarged cross-sectional view of the raising mechanism of the blind in FIG. 1. The raising mechanism 300 includes a roller 301, a fixed mount base 302, an adjusting component 303, a positioning component 304, a connecting shaft 305, a positioning cover 306, an elastic component 307, a dust-proof cover 308 and at least one second string 309.

The roller 301 is disposed in the accommodating space S1 and rotatably disposed on the main bodies 2110 of the mount bases 211 of the adjustment assemblies 210. The roller 301 has an axis D3 perpendicular to the axis D1 of the first gears 213 so that the first gears 213 are allowed to be located between the roller 301 and the bottom plate 101. As such, the mechanism of the angle adjustment device 200 and the raising mechanism 300 in axial direction thereof can be simplified and the accommodating space S1 can be efficiently utilized.

The fixed mount base 302 is fixed on the bottom plate 101 of the headrail 100. The adjusting component 303 is rotatably disposed on the fixed mount base 302. The positioning component 304 is fixed to the adjusting component 303 and has a first gear part 3040. The connecting shaft 305 is located in the roller 301 and is also fixed to the adjusting component 303.

The positioning cover 306 is fixed to the roller 301 and has two pivotable second gear parts 3060. The two second gear parts 3060 are detachably engaged with the first gear part 3040.

The elastic component 307 is, for example, a torsion spring, and is sleeved on the connecting shaft 305. Two opposite ends of the elastic component 307 are respectively fixed to the connecting shaft 305 and the positioning cover 306.

The dust-proof cover 308 is fixed to a side of the positioning cover 306 away from the roller 301 in order to protect the positioning cover 306 and the positioning component 304. However, the dust-proof cover 308 is optional.

In this embodiment, the amount of the at least one second string 309 is, for example, three. The three second strings 309 are installed on the roller 301 and respectively disposed through the second through holes H2 of the main bodies 2110. In detail, for each main body 2110, one of the second strings 309 is disposed through the second through hole H2, that is located between the other two second through holes H2, and clamped by the smooth rod 2151 and the smooth rod 2152, such that the second strings 309 are held in position. Therefore, the second strings 309 are prevented from being worn and able to be moved in a smooth manner.

The first strings 214 and the second strings 309 serially connect the slats 400 so that the slats 400 are hung on a side of the headrail 100. In addition, the blind 10 further includes a plate 500 that is located at a side of the slats 400 away from the headrail 100 via the second strings 309. In other embodiments, for improving the convenience of operation, a handle can be additionally disposed on a side of the plate away from the slats.

It is noted that the amount of the adjustment assemblies 210 may be adjusted according to actual requirements, such as the length of the slat. Therefore, it is understood that the amount of the outer teeth and the second strings may be adjusted accordingly.

The angles of the slats 400 can be adjusted by pulling the cord 250 to rotate the second gear 235. In detail, while pulling the cord 250, the cord 250 forces the second gear 235 to rotate, the rotation of the second gear 235 forces the third gear 240 to rotate so as to rotate the shaft 220 which is fixed to the third gear 240, such that the outer teeth 222 of the shaft 220 respectively force the first gears 213 and the string pulleys 212 of the adjustment assemblies 210 to rotate, thereby moving the first strings 214. During the movement of the first strings 214, the first adjustment portion 2141 and the second adjustment portion 2142 are moved in opposite directions in order to adjust the angles of the slats 400.

Then, the slats 400 can be lowered by pulling the plate 500 away from the headrail 100. In detail, while pulling the plate 500 away from the headrail 100, the plate 500 pulls the second strings 309 downwards, and the second strings 309 force the roller 301 to rotate, such that the positioning cover 306 is rotated to detach the second gear parts 3060 from the first gear part 3040 of the positioning component 304. During the rotation of the positioning cover 306, the elastic component 307 that is fixed to the positioning cover 306 stores elastic potential energy. As the slats 400 is not pulled by the plate 500, the gear parts 3060 of the positioning cover 306 engage with the first gear part 3040 of the positioning component 304 so as to fix the slats 400 in the current location. When the plate 500 is being pulled again, the second gear parts 3060 are forced to detach from the first gear part 3040. At this moment, the elastic component 307 releases the stored elastic potential energy to rotate the positioning cover 306 and the roller 301 in order to raise the slats 400 toward the roller 301.

Conventional blinds must have a pull cord for the user to lower or raise the slats. However, as described above, since the slats 400 are lowered or raised by directly pulling the plate 500, there is no need to dispose a pull cord for lowering or raising the slats 400.

Additionally, the elastic potential energy stored by the elastic component 307 can be adjusted to a proper degree by rotating the adjusting component 303, such that the elastic potential energy stored by the elastic component 307 would not be too small to raise all of the slats 400 or so large that the elastic potential energy causes the slats 400 to damage the roller 301. In detail, while rotating the adjusting component 303, the adjusting component 303 rotates the connecting shaft 305 so as to force the connecting shaft 305 to rotate the elastic component 307, thereby adjusting the degree of the stored elastic potential energy.

As the blind and the angle adjustment device thereof discussed above, since the axis of the first gear is perpendicular to that of the shaft, the first gear can be located between the bottom plate and the roller of the raising mechanism. Accordingly, more available space is created in the headrail for installing other components.

Moreover, since the smooth rods are located above the second through holes, the first strings and the second strings can cross over and be in contact with the smooth surfaces of the smooth rods as moved. Thus the first strings and the second strings would not be worn and can be moved in a smooth manner.

Furthermore, by rotating the adjusting component, users can adjust the elastic potential energy stored by the elastic component such that the elastic potential energy would not be too small to raise all of the slats or so large that the elastic potential energy causes the slats to damage the roller.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An angle adjustment device, configured to adjust angles of slats of a blind, the angle adjustment device comprising:
at least one adjustment assembly, comprising a mount base, a string pulley, a first gear and a first string, the string pulley pivotably disposed on the mount base, the first gear fixed on the string pulley, and the first string installed on the string pulley and configured to connect the slats; and
a shaft, comprising a lengthy part and at least one outer tooth fixed on the lengthy part, wherein the at least one outer tooth is engaged with the first gear;
wherein, an axis of the first gear is perpendicular to an axis of the shaft.

2. The angle adjustment device according to claim 1, wherein the mount base comprises a main body and an assemble board, the string pulley is pivotably disposed on the main body, the assemble board stands on the main body, the assemble board has at least one first through hole, the main body has at least one second through hole, the first string is disposed through the at least one first through hole and the at least one second through hole.

3. The angle adjustment device according to claim 2, wherein the at least one adjustment assembly further comprises at least one smooth rod, the at least one smooth rod is disposed on the main body and is located above the at least one second through hole.

4. The angle adjustment device according to claim 1, wherein the at least one outer tooth of the shaft and the first gear has a gear ratio of 1:10.

5. The angle adjustment device according to claim 1, further comprises a second gear, a third gear and a cord, the second gear is engaged with the third gear, the shaft is fixed to the third gear, and the cord is connected to the second gear.

6. The angle adjustment device according to claim 5, wherein the second gear and the third gear has a gear ratio of 2:1.

7. A blind without pull cord, comprising:
a headrail, comprising a bottom plate and two side plates, the two side plates respectively disposed at two opposite sides of the bottom plate, and the two side plates and the bottom plate together forming an accommodating space;
an angle adjustment device, disposed in the accommodating space, the angle adjustment device comprising at least one adjustment assembly and a shaft, the at least one adjustment assembly comprising a mount base, a string pulley, a first gear and a first string, the string pulley pivotably disposed on the mount base, the first gear fixed on the string pulley, the first string installed on the string pulley, the shaft comprising a lengthy part and at least one outer tooth fixed on the lengthy part, wherein the at least one outer tooth is engaged with the first gear and an axis of the first gear is perpendicular to an axis of the shaft;
a raising mechanism, comprising a roller and at least one second string, the roller disposed in the accommodating space and rotatably disposed on the mount base of the at least one adjustment assembly, and the at least one second string installed on the roller; and
a plurality of slats, the first string and the least one second string connecting the plurality of slats so that the plurality of slats are hung on a side of the headrail;
wherein, the first gear is located between the roller and the bottom plate.

8. The blind according to claim 7, wherein the raising mechanism comprises:
a fixed mount base, fixed to the bottom plate of the headrail;
an adjusting component, rotatably disposed on the fixed mount base;
a positioning component, fixed to the adjusting component;
a positioning cover, fixed to the roller and detachably engaged with the positioning component;
a connecting shaft, fixed to the adjusting component; and
an elastic component, two opposite ends of the elastic component respectively fixed to the connecting shaft and the positioning cover.

9. The blind according to claim 8, wherein the raising mechanism further comprises a dust-proof cover fixed to a side of the positioning cover away from the roller.

10. The blind according to claim 7, wherein an amount of the at least one adjustment assembly, an amount of the at least one outer tooth and an amount of the at least one second string are three.

11. The blind according to claim 7, wherein the mount base comprises a main body and an assemble board, the string pulley is pivotably disposed on the main body, the assemble board stands on the main body, the assemble board has at least one first through hole, the main body has at least one second through hole, the first string is disposed through the at least one first through hole and the at least one second through hole.

12. The blind according to claim 11, wherein the at least one adjustment assembly further comprises at least one smooth rod, the at least one smooth rod is disposed on the main body and is located above the at least one second through hole.

13. The blind according to claim 7, wherein the at least one outer tooth of the shaft and the first gear has a gear ratio of 1:10.

14. The blind according to claim 7, further comprises a second gear, a third gear and a cord, the second gear is engaged with the third gear, the shaft is fixed to the third gear, and the cord is connected to the second gear.

15. The blind according to claim 14, wherein the second gear and the third gear has a gear ratio of 2:1.
